(19) United States
(12) Patent Application Publication
(10) Pub. No.: US 2006/0095582 A1
(43) Pub. Date: May 4, 2006

(54) Device and method for transferring apportioned data in a mobile ad hoc network

(76) Inventors: Narasimhan Nitya, Schaumburg, IL (US); Venu Vasudevan, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 10/977,140

(22) Filed: Oct. 29, 2004

(51) Int. Cl. G06F 15/16

(52) U.S. Cl. 709/236

(57) ABSTRACT

A wireless communication device (101) for communicating data portions of data over an ad hoc network is provided. The wireless communication device comprises a scheduling circuit (209), a transceiver (213, 219, 225) operating via a wireless link of the ad hoc network, and an integration circuit (239). The scheduling circuit is configured to identify a plurality of data portions to divide the data. The transceiver is configured to discover a plurality of remote devices having one or more data portions of the data and transmit a task associated with the one or more data portions of the data to the plurality of remote devices. The integration circuit is configured to assemble the plurality of data portions.

### FIELD OF THE INVENTION

The present invention relates generally to the field of ad hoc networks for mobile devices. In particular, the present invention relates to a device and method for transferring data from multiple devices to a single device over a mobile ad hoc network.

### BACKGROUND OF THE INVENTION

Mobile devices are being equipped with short-range networking interfaces, allowing them to interact with peers in their vicinity, i.e., in ad hoc mode, to discover new content and to access services provided by these peers. For instance, if one mobile device having a tribal game meets another mobile device that does not have the tribal game, then the tribal game may be copied between devices so that users of both devices may cooperatively play the game with or against each other.

One concern with mobile ad hoc networks is that the mobility of these peer nodes provides a limited “window of opportunity” for users interested in downloading content that they have dynamically “discovered” on that device. This is particularly true for payload-intensive downloads, where the non-trivial download times increase the probability that the content host will move out of transmission range before the download can complete successfully. Although robust file transfer mechanisms for distributed networks are known, these systems are reactive (i.e., will be triggered once a connection is restored between the same two endpoints) and do not address new challenges posed by mobile ad hoc networks based on the resource constraints and the inherent mobility of the participating hosts.

Another concern with mobile ad hoc networks is the power and resource constraints of the devices involved. Content downloads can consume time and energy if the content is sufficiently large. In many cases, the content host may find itself unable or unwilling to expend its limited resources on serving the locally-stored content to a remote peer, especially if the unreliable nature of the wireless network requires repeated retries to ensure successful completion of the download.

Accordingly, there is a need for a mechanism that allows a mobile device to download data successfully within the small window of opportunity, limited by its transmission range relative to one or more sources of the data. The mechanism would need to avail itself of situations where multiple sources of the data may be seen concurrently within a small time frame as well as multiple sources of data being seen at different times in a serial fashion. The mechanism should also avail itself of situations where multiple sources of “partial” data can be seen either concurrently or in serial fashion. The term “partial” refers to modular segments of the data that can be identified independently and can be reassembled to restore the original data entity. The mechanism should enable potentially large content transfers to be performed between peer devices in a manner that is robust (i.e., succeeds even in the face of device and network failures or limitations), efficient (i.e., minimizes resource depletion at all devices involved) and timely (i.e., completes the task in minimal time so as to exploit the narrow window of opportunity afforded by a potentially-mobile peer provider).

### BRIEF DESCRIPTION OF THE DRAWINGS

FIG. 1 is a system diagram illustrating exemplary interaction among mobile devices in accordance with the present invention.

FIG. 2 is a block diagram illustrating exemplary components of a mobile device in accordance with the present invention.

FIG. 3 is a flow diagram illustrating a first part of an exemplary operation of a mobile device in accordance with the present invention.

FIG. 4 is a flow diagram illustrating a second part of the exemplary operation of the mobile device of FIG. 3.

### DETAILED DESCRIPTION OF THE PREFERRED EMBODIMENTS

The present invention uses an integration-of-concurrent-transfers approach wherein multiple transfers are initiated concurrently, i.e., each to a different peer for a different module/data portion of the required data, with the transferred components subsequently integrated to restore the required content on the requesting device. Also, the effective load and energy requirements on individual peer sources of the content are reduced, allowing resource-poor peers to participate in the data transfer process and effectively increasing the number of peers that can act as data sources. The present invention provides an incremental transfer mechanism where a mobile device can take advantage of opportunities to receive portions of content from each peer-to-peer encounter, and gradually assemble the complete content. This approach is effective, despite the inherent instability of wireless network connections, due to the frequency of peer-to-peer encounters of prevalent mobile devices. Furthermore, the present invention proactively searches for alternative data sources that are available to provide the requested data. A service discovery mechanism is employed to scan for alternative sources so that successful downloads may be completed.

The present invention may be applied to transfer of any kind of content between peer devices in a mobile ad hoc network. Data transfer may occur in the context of terminal management or in the context of application downloads at user-request. The present invention may also be applied to all mobile terminals that are equipped with a short-range networking interface (e.g., IEEE 802.11, Bluetooth, and the like).

The present invention is particularly effective for data having certain facilitating characteristics. For example, significant value is added for data that is modular in nature, facilitating fragmentation into data portions and subsequent reassembly without loss of information. Examples of modular data include, but are not limited to, ASCII files that may be subdivided into multi-byte portions and Java Jar files that may be subdivided into individual Jar Entry components. Also, significant value is added for data that may be identified uniquely using a data identifier, such as a file name or application identification, with all instances of the data (located on different hosts) maintaining the same identity.

One aspect of the present invention is a method for receiving data portions of data over an ad hoc network. A plurality of data portions is identified to divide the data. A plurality of remote devices having one or more data portions of the data is then discovered via a wireless link of the ad hoc network. Next, a task associated with the one or more data portions of the data to the plurality of remote devices is assigned via the wireless link of the ad hoc network. Thereafter, the plurality of data portions is assembled.

Another aspect of the present invention is a method for transmitting one or more data portions of data over an ad hoc network. A broadcast for one or more data portions of the data is received via a wireless link of the ad hoc network from a remote device. An acknowledgment that the one or more data portions of data are available to the remote device is then transmitted via the wireless link of the ad hoc network. Next, a unicast requesting the one or more data portions of the data from the remote device is received via the wireless link of the ad hoc network. Thereafter, transfer of the one or more data portions of the data is initiated via the wireless link of the ad hoc network to the remote device.

Yet another aspect of the present invention is a wireless communication device for receiving data portions of data over an ad hoc network comprising a scheduling circuit, a transceiver operating via a wireless link of the ad hoc network, and an integration circuit. The scheduling circuit is configured to identify a plurality of data portions to divide the data. The transceiver is configured to discover a plurality of remote devices having one or more data portions of the data and transmit a task associated with the one or more data portions of the data to the plurality of remote devices. The integration circuit is configured to assemble the plurality of data portions.

Still another aspect of the present invention is a wireless communication device for transferring one or more data portions of data over an ad hoc network comprising a transceiver operating via a wireless link of the ad hoc network. The transceiver is configured to transmit an acknowledgment that one or more data portions of the data is available in response to receiving a broadcast for the one or more data portions of the data from a remote device, and initiate transfer of the one or more data portions of the data to the remote device in response to receiving a unicast requesting the one or more data portions of the data from the remote device.

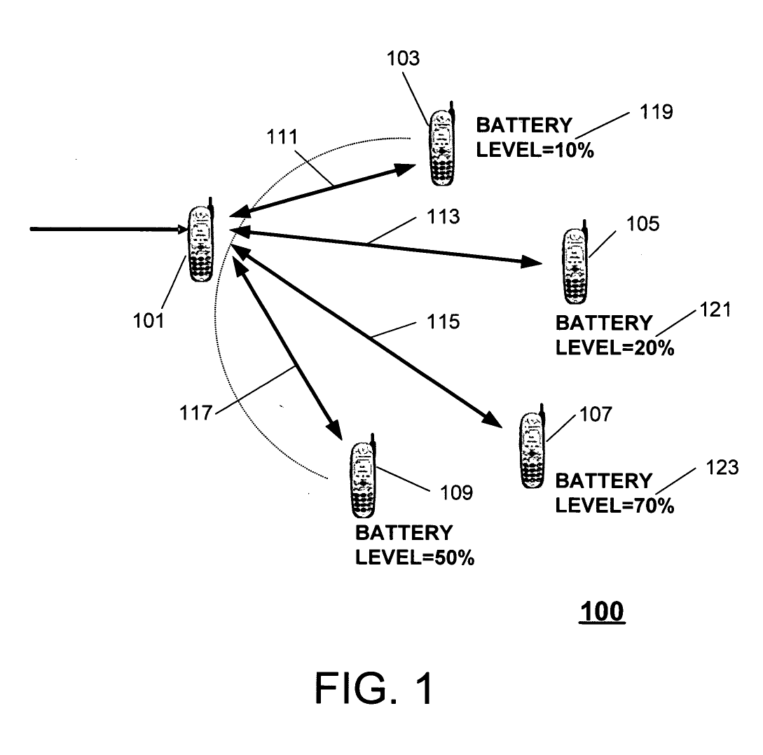

Referring to FIG. 1, there is shown an exemplary interaction among mobile devices, including a requesting device that desires data and multiple peer devices that may provide the data, in accordance with the present invention. In particular, a requesting device 101 sends a request for data, such as a file or group of files. The requesting device determines, from data annotations, that the file may be separated into certain number of data portions. For example, as stated above, the present invention is particularly effective for data that is modular in nature, facilitating fragmentation into data portions and subsequent reassembly without loss of information. Examples of modular data include, but are not limited to, ASCII files that may be subdivided into multi-byte portions and Java Application Resource (Jar) files, developed by Sun Microsystems, Inc., that may be subdivided into individual Jar Entry components. For the latter example, Java uses separate files to package each Java class, and a Java application includes of a collection of classes and possibly other resources. These are usually packaged together in a compressed file called a JAR (Java Application Resource) file.

The requesting device 101 may initiate a discovery process by broadcasting a request for data via wireless communication links 111, 113, 115, 117. Peer devices 103, 105, 107, 109, in the vicinity of the requesting device 101, or more particularly within broadcast range of the requesting device, have an opportunity to receive the request via the wireless communication links 111, 113, 115, 117, respectively. In response to the request, each peer device 103, 105, 107, 109 may respond with resource information relating to its ability to provide information about the data to the requesting device 101, or the requesting device only receives responses from the peer devices capable of providing information about the data. For one embodiment, three peer devices 103, 105, 107 respond with information indicating their ability to provide service whereas a fourth peer device 109 responds that it is unable to provide any service relating to the requested data, e.g., it does not have any part of the requested data or it does not have enough power to perform any transfers. For another embodiment, instead of responding that it is unable to provide service, the fourth peer device 109 does not respond to the request. Each of the other peer devices 111, 113, 115 responds with resource information, such as the portions of the data available for transfer as well as its power level 119, 121, 123.

The requesting device 101 then determines initial static assignments based on the responses received from the other peer devices 103, 105, 107, capable of providing the requested information, in its entirety or a portion thereof. For the example shown in FIG. 1, a first peer device 103 has 10% stored power, a second peer device 105 has 20% stored power, and a third peer device 107 has 70% stored power. For one embodiment, the requesting device 101 may distribute tasks based on the capability of the other peer devices 103, 105, 107, to provide services, such as the stored power levels of the devices. For example, the requesting device 101 may distribute a first task corresponding to one data portion to the first peer device 119 having 10% stored power, a second task corresponding to two data portions to the second peer device 121 having 20% stored power, and a third task corresponding to the seven data portions to the third peer device 123 having 70% stored power. After the assignments are determined, the requesting device may dispatch the assigned task to each peer device 103, 105, 107, via the wireless communication links 111, 113, 115.

These task assignments are preliminary based on currently known information and may be modified dynamically based on updated information about the peer devices 103, 105, 107, such as arrival of another peer device, departure of a currently identified peer device, and completion/no completion of tasks by a peer device. For instance, if the first peer device 103 is no longer within communication range of the requesting device 101, then the requesting device may reassign the first peer device's task to the second or third peer device 105, 107. As another example, the requesting device 101 may reassign a data portion of a task from the third peer device 107 to the second peer device 105 if the second peer device completes the second task early and its resources permit the additional work.

It is to be understood that the present invention may utilize multiple wireless communication technologies and is not necessary restricted to the use of just one technology. For example, in another embodiment, the process of discovering devices having data portions may be performed using one wireless network, while the process of receiving or downloading data portions may be performed over a different wireless network between the two devices. They may be various reasons for utilizing multiple technologies, such as for energy-conservation purposes. For instance, the discovery process may involve broadcasts over a low-power network (e.g., Bluetooth and infrared). Once a peer device decides to contribute by transmitting a portion of the data to the requesting device, both devices may use a more efficient but higher-power wireless network (e.g., WLAN) to complete the data transfer.

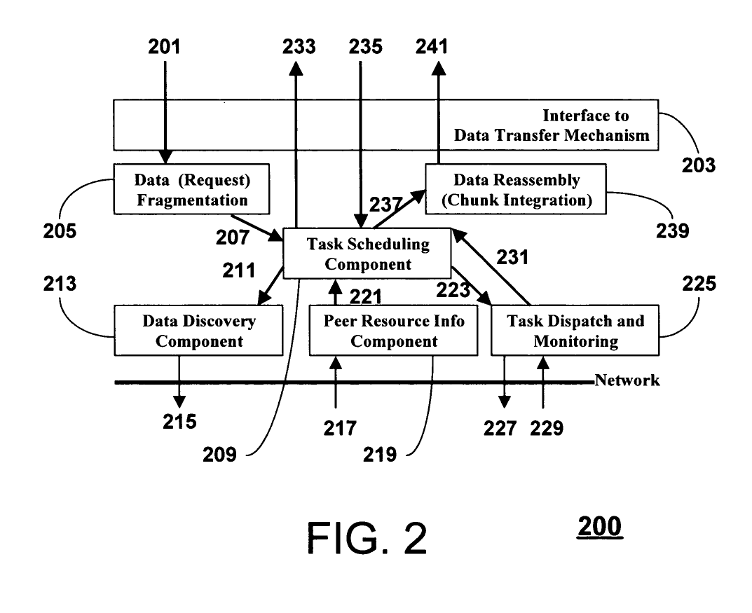

Referring to FIG. 2, there is shown a high level model of the file transfer operation to be hosted on each mobile device. Initially, all peer devices in the vicinity that can provide the required content are discovered. The resource availability on each peer devices is determined. Possible information relating to resource availability on each peer device includes, but is not limited to, store power (such as battery level), indications of mobility (e.g., fading signal), and distance (e.g., hop count in multi-hop networks). Next, the granularity at which the content can be obtained is determined. For example, a Java jar file may be separated into individual Jar Entry components, an ASCII file can be broken into data portions of some preset size, etc. Upon determining the granularity, a quantity of modular components or data portions are determined and a task is associated with one or more data portions. Each task is then dispatch to its corresponding peer device based on the resource information previously received from the peer devices. Next, each task is monitored for completion. If a specific task is not complete for one reason or another (such as, a peer device moving out of range), then the task may be rescheduled or reassigned. Finally, after all data portions are received by the requesting device, the data portions are assembled to recreate the data in its entirety.

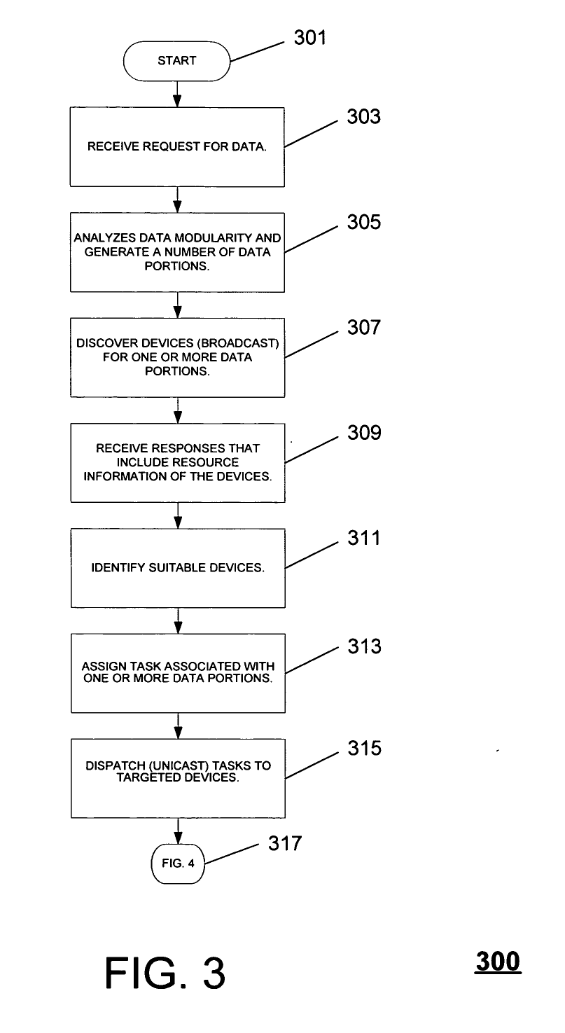

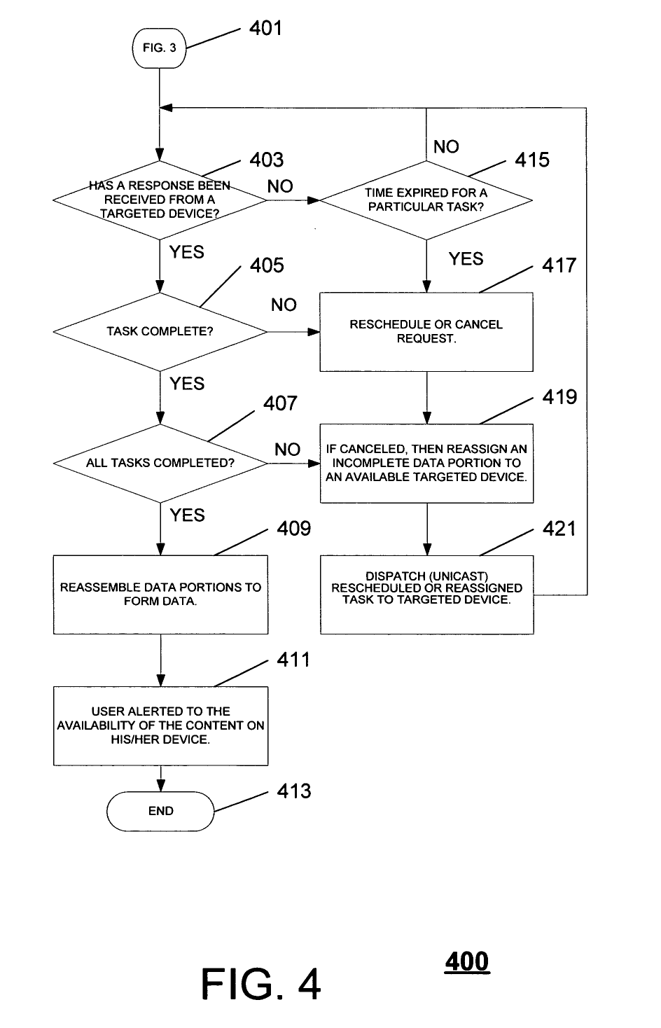

FIG. 2 shows exemplary components of a mobile device 200, and FIGS. 3 and 4 represent an exemplary operation of the requesting mobile device 200. After initiating the process at step 301, a request 201 for data (such as a file or a group of files) is received by an interface 203 of the data transfer mechanism, at step 303, and forwarded to a data fragmentation component 205 of the requesting mobile device 200. The request 201 may be activated either explicitly by user interaction with a user interface (not shown) of the requesting mobile device or automatically (programmed) by an application running on that mobile device. The data fragmentation component 205 sends information 207 about the requested data to a task scheduling component 209 of the requesting mobile device 200, which analyzes data modularity of the requested data and determines a quantity of data portions to separate the requested data at step 305. The task scheduling component 209 is a dynamic scheduling component that evaluates the resources of discovered devices to determine a static assignment of data portion transfer tasks to devices, and subsequently reassigns tasks dynamically based on notifications of the arrival/departure of suitable peer devices, and the completion/failure of individual data portion transfers. Additional “meta-data” may be used to prioritize the discovery of selected portions of the data either because of content priority or because of resource constraints. For instance, it may be determined that the data is best modularized as portions {A, B, C} where A, B and C are self-contained modules representing, for example, an advertisement (A), headlines for the day (B), and an actual news report (C). In such cases, the scheduler can prioritize discovery based on content (e.g., get me the headlines segment “B” first) or can prioritize on other factors such as size (e.g., since C is the largest segment, prioritize transfer of C if a battery-rich source for that data is discovered). Note that this mechanism can be used in a recursive manner if required. For instance, the task of getting data module C can itself be treated as a new data request that is further broken down into smaller tasks by the mechanism.

The task scheduling component 209 provides a signal 211 to a transceiver, or more particularly a data discovery component 213 of the transceiver, to initiate a discover process to identify peer devices in the vicinity of the requesting mobile device 200. The data discovery component 213 is a dynamic discovery component to identify all peer mobile devices in the ad hoc network that have this content available locally. In response to receiving the signal 211, the data discovery component 213 sends a broadcast via wireless communication to identify any peer devices within short-range communication range with the requesting mobile device 200 at step 307. Examples of short-range communication technologies are a peer-to-peer or ad hoc communications that include, but are not limited to, HomeRF, Bluetooth and IEEE 802.11 (a, b or g), infrared, and the like.

Responses 217 to the broadcast are received by a peer resource information component 219 of the transceiver, at step 309. The peer resource information component 219 forwards resource information 221 of the responses 217 to the task scheduling component 209. The task scheduling component 209 receives the resource information about peer devices having one or more data portions of the requested data and, thus, thereby identifies suitable peer mobile devices at step 311. Next, the task scheduling component 209 assigns tasks associated with one or more data portions to the suitable peer mobile devices at step 313, and provides the tasks 223 to a task dispatch and monitoring component 225 of the transceiver. The task dispatch and monitoring component 225 dispatches via unicast each task 227 to its corresponding peer mobile device at step 315. As shown in FIG. 3, step 317 corresponds to step 401 of FIG. 4 to show that the process continues with step 403.

After the tasks are communicated to the peer mobile devices, the task scheduling component 209 and the task dispatch and monitoring component 225 perform a series of steps to ensure that all tasks are completed. When the task dispatch and monitoring component 225 receives a response 229 to a particular task at step 403, the signal 231 including the response is provided to the task scheduling component 209 to determine whether the task was completed by the assigned peer mobile device at step 405. As these steps are repeated for each received task, the task scheduling component 209 will track the responses until it determines that all tasks have been completed at step 407. Also during these time period of awaiting and receiving status reports for the tasks, the task scheduling component 209 may present messages 233 to the user of the requesting device, via a user interface, in order to solicit input 235 from the user, such as operational instructions when tasks are not completed as originally planned and assigned by the task scheduling component. Alternatively, the task scheduling component 209 may present messages 233 to an application, via an application programming interface, in order to provide status information and solicit input 235 from the application that is using this mechanism.

Once all tasks have been completed (or as each task is completed), the task scheduling component 209 provides all of the received data portions 237 received from the various peer mobile devices to a data reassembly component 239. Note that the mechanism supports the ability to receive data portions out-of-order, with the portions subsequently being reassembled in order on the device using any appropriate fragment numbering scheme. For example, the mobile device may assemble modular components of the data portions instead of assembling all data portions after all tasks have been completed. A modular component may correspond to a subset of the data portions that have been received from the peer devices. Accordingly, the data reassembly component 239 assembles the data portions to form the requested data at step 409, and provides the requested data 241 to another component (not shown) of the requesting device for storage, such as a memory portion, or for utilization, such as a processor or user interface. Optionally, an alert may be provided to the user via a user interface which indicates the availability of the data or content on the requesting device, as represented by step 411. Alternatively, the mechanism may begin providing the data to the user or application as soon as sufficient contiguous (sequentially complete) and modular portions of the data have been obtained and assembled. Thus, a user or application may begin to use or render the initial data contents even as the final modular segments are being gathered. For instance, a media player looking for a news clip may begin playing the movie trailers and advertisements embedded in that clip as and when they are obtained, instead of waiting till the entire clip has been reassembled. Thereafter, the process terminates at step 413.

For another embodiment, the task scheduling component 209 may set a time limit for completing each task or each data portion of a task, which may or may not be provided to the peer mobile device to perform the task. If the time limit for a particular task or data portion has not yet expired at step 415, then the requesting mobile device may continue to await responses from the peer mobile devices at step 403. On the other hand, if a particular time period expires, then the task scheduling component 209 may make different plans for completing the task associated with the expired time period at step 417. For one embodiment, the task scheduling component 209 may cancel the request for performing the task at step 417, reassign the task or any incomplete data portions of the task to a different peer mobile device having availability to perform the task or complete the data portion at step 419, and dispatch via unicast the reassigned task or data portion to the different peer mobile device at step 421. For another embodiment, the task scheduling component 209 may reschedule the task to extend the time period for the peer mobile device to complete the task at step 417 and dispatch via unicast the reassigned task or data portion to the different peer mobile device at step 421. For yet another embodiment, the task scheduling component 209 may present a message 233 to the user, via a user interface, to solicit input 235 about whether the task or data portion associated with the time expiration should be canceled or rescheduled. After the task or data portion is rescheduled or reassigned, the task scheduling component 209 will again await a response at step 403.

Referring back to steps 405 and 407, the task scheduling component 209 may take certain action when tasks are not completed. If a response is received indicating that a particular task has not completed, at step 405, then the task scheduling component 209 may make a different plans for completing the task associated with the incomplete status at step 417. As stated above, the task scheduling component 209 may be preprogrammed or respond to user input to either reschedule or reassign the incomplete task or incomplete data portion (at steps 417, 419 & 421). If the most recent task has been completed but all tasks have not been complete, at step 407, then the peer mobile device that completed the most recent task may be available to pick up a task, or a portion thereof, that has not yet been completed by another peer mobile device. Thus, the task scheduling component, may reassign the task, or portion of the task, from a busy peer mobile device to a peer mobile device having available capacity, at steps 419 and 421. After the task, or portion thereof, is rescheduled or reassigned, the task scheduling component 209 will again await a response at step 403.

The present invention may also utilize tuplespaces to automated, asynchronous operation. For yet another embodiment, the notion of local tuplespaces on each device may be exploited. Tuplespaces are data stores that provide data retrieval based on template-matching. However many tuplespaces provide event-notification mechanisms that allow event handlers to be notified based on the addition/removal or modification of a data entry (tuple) in that tuplespace.

By exploiting tuplespaces, an asynchronous, event-based transfer system and method that operates in an automated manner may be implemented. In particular, a user may request data D and cause a RequestTuple(D) to be placed in tuplespace. A scheduler may pre-register for notification of RequestTuples and is, thus, notified. The scheduler extracts the tuple and creates a DiscoveryRequestTuple(D) for the data. The scheduler also registers to be notified of DiscoveryResultTuples. The scheduler then creates a FragmentRequestTuple(D) for the data and registers to be notified of FragmentResponseTuples.

A discovery component then pre-registered to be notified of DiscoveryRequestTuples. The discovery component extracts the tuple and initiates a discovery process for the data. For each peer mobile device that responds, the discovery component creates a DiscoveryResponseTuple(D, P, R) where D is the data contained on peer mobile device P with current resources R.

Next, a fragmentation component pre-registers to be notified of FragmentRequestTuples. The fragmentation component extracts the tuple, uses annotated information about the modularity of the data (=number of data portions, n) and creates n PortionTaskTuple(D, PortionNumber) that are placed in the tuplespace. The fragmentation component also places a FragmentResponseTuple in the space containing the count and identifiers of the PortionTaskTuples associated with data request D.

Thereafter, the scheduler is notified of the FragmentResponseTuple and of DiscoveryResponseTuples as they occur. Using the resource information in the discovery responses, the scheduler performs a static assignment of tasks to peers and places one DispatchRequestTuple(P, PortionTaskTupleID) for each peer to reflect first assignment to each peer. The scheduler also registers to be notified of DispatchResponseTuples. The dispatcher component then pre-registers to be notified of DispatchRequestTuples. The dispatcher extracts them and dispatches the specified PortionTask to the specified peer. The results (i.e., portion data or failure notification) are placed in a DispatchResponseTuple(P, PortionTaskTupleID, Status) and placed in tuplespace.

The scheduler monitors the dispatch responses and takes corrective (rescheduling) action as necessary. When it has ascertained that all data portions tasks are done, an IntegrationTaskTuple(DispatchResponseTupleIDs) is placed in the tuplespace, listing the identifiers of the response tuples that contain the data portions. Alternatively, IntegrationTaskTuple(DispatchResponseTupleIDs) may be placed in the tuplespace as and when dispatch responses are received, to enable as-you-go reassembly of data. The integration component pre-registers to be notified of IntegrationTaskTuples. The integration component retrieves the tuple, reassembles the data and stores it locally, then places a UserAlertTuple(Data d) in the tuplespace. An appropriate user interface handler can register to be notified of user alerts, and can handle the occurrence of such tuples by displaying a suitable alert to the user (if necessary) or by updating local inventory information. For another embodiment, the integration component may create a local buffer to store data and alert the user (or application) as soon as sufficient contiguous data portions have been assembled up front. The alert then provides the user (or application) with a handle to the data buffer to which subsequently-assembled data portions are appended as they are completed.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for receiving data portions of data over an ad hoc network, the method comprising:
identifying a plurality of data portions to divide the data;
discovering, via a first wireless link, a plurality of remote devices, each remote device having at least one data portion of the data;
assigning a task associated with the at least one data portion to each remote device;
receiving, via a second wireless link, the at least one data portion from each remote device; and
assembling the plurality of data portions.

2. The method of claim 1, wherein discovering a plurality of remote devices comprises:
broadcasting, via the first wireless link, a request to the plurality of remote devices for the at least one data portion of the data; and
receiving, via the first wireless link, a plurality of acknowledgments from the plurality of remote devices in response to the broadcast of the request.

3. The method of claim 1, wherein assigning a task associated with the at least one data portion to each remote device comprises:
unicasting, via one of the first and second wireless links, each task to the corresponding remote device.

4. The method of claim 1, wherein assembling the plurality of data portions comprises:
determining whether all of the plurality of data portions have been received from the plurality of remote devices; and
assembling the plurality of data portions in response to determining that all of the plurality of data portions have been received.

5. The method of claim 1, further comprising determining that a subset of the data portions, including all data portions required for assembling one modular component of the data, have been received from the plurality of remote devices, wherein
assembling the plurality of data portions includes assembling the subset in response to determining that the subset of the data portions required for assembling the one modular component of the data has been received.

6. The method of claim 1, further comprising:
receiving a request for the data from a user of a wireless communication device; and
notifying the user that the data is available for use on the wireless communication device.

7. The method of claim 1, further comprising rescheduling a particular task in response to receiving a particular result indicating that the particular task is incomplete.

8. The method of claim 1, further comprising sending a new task to a particular device in response to receiving a particular result indicating that a previous task assigned to the particular device is complete.

9. The method of claim 8, wherein the new task was previously assigned to a device different from the particular device but has been reassigned to the particular device.

10. The method of claim 1, wherein assigning a task associated with the at least one data portion to each remote device includes providing a time period for completion associated with each task.

11. The method of claim 10, wherein assigning a task associated with the at least one data portion to each remote device includes determining whether the result for each task indicates that the time period for completion expired before the task was completed.

12. A method for transmitting one or more data portions of data over an ad hoc network, the method comprising:
receiving, via a wireless link of the ad hoc network, a broadcast for at least one data portion of the data from a remote device;
transmitting, via the wireless link of the ad hoc network, an acknowledgment that the at least one data portion of the data is available to the remote device;
receiving, via the wireless link of the ad hoc network, a unicast requesting the at least one data portion of the data from the remote device; and
initiating transfer, via the wireless link of the ad hoc network, of the at least one data portion of the data to the remote device.

13. The method of claim 12, further comprising:
indicating, via the wireless link of the ad hoc network, that the transfer of the at least one data portion of the data is incomplete; and
receiving, via the wireless link of the ad hoc network, a rescheduling request from the remote device in response to indicating that the transfer is incomplete.

14. The method of claim 12, further comprising
indicating, via the wireless link of the ad hoc network, that the transfer of the at least one data portion of the data is complete; and
receiving, via the wireless link of the ad hoc network, a new request for another data portion of the data from the remote device in response to indicating that the transfer is complete.

15. The method of claim 12, wherein receiving a unicast requesting the at least one data portion of the data from the remote device includes receiving a time period for completion associated with the unicast.

16. The method of claim 12, further comprising determining whether the time period for completion expired before the transfer was completed.

17. A wireless communication device for receiving data portions of data over an ad hoc network comprising:
a scheduling circuit configured to identify a plurality of data portions to divide the data;
a transceiver, operating via a wireless link of the ad hoc network, configured to discover a plurality of remote devices having at least one data portion of the data and transmit a task associated with the at least one data portion of the data to the plurality of remote devices; and
an integration circuit configured to assemble the plurality of data portions.

18. The wireless communication device of claim 17, wherein the transceiver discovers the plurality of remote devices by broadcasting a request to the plurality of remote devices for the at least one data portion of the data, and receiving a plurality of acknowledgments from the plurality of remote devices in response to the broadcast of the request.

19. The wireless communication device of claim 17, wherein the transceiver transmits the task to the plurality of remote devices by unicasting each task to the corresponding remote device, and receiving a result for each task in response to unicasting each task.

20. The wireless communication device of claim 17, wherein the integration circuit assembles the plurality of data portions by determining whether all of the plurality of data portions have been received from the plurality of remote devices, and assembling the plurality of data portions in response to determining that all of the plurality of data portions have been received.

21. The wireless communication device of claim 17, wherein the integration circuit assembles a subset of the plurality of data portions to form a modular component of the data before all of the plurality of data portions have been received from the plurality of remote devices.

22. The wireless communication device of claim 17, wherein the scheduling circuit receives a request for the data from a user of a wireless communication device and notifies the user that the data is available for use on the wireless communication device.

23. The wireless communication device of claim 17, wherein the scheduling circuit reschedules a particular task in response to receiving, via the transceiver, a particular result indicating that the particular task is incomplete.

24. The wireless communication device of claim 17, wherein the scheduling circuit sends a new task to a particular device in response to receiving, via the transceiver, a particular result indicating that a previous task assigned to the particular device is complete.

25. The wireless communication device of claim 24, wherein the scheduling circuit previously assigned the new task to a different device but reassigns the new task to the particular device.

26. The wireless communication device of claim 17, wherein the transceiver sends a time period for completion associated with each task.

27. The wireless communication device of claim 26, wherein the scheduling circuit determines the time period for completion expired before the task was completed.

28. A wireless communication device for transferring one or more data portions of data over an ad hoc network comprising:
a transceiver, operating via a wireless link of the ad hoc network, configured to transmit an acknowledgment that at least one data portion of the data is available in response to receiving a broadcast for the at least one data portion of the data from a remote device, and initiate transfer of the at least one data portion of the data to the remote device in response to receiving a unicast requesting the at least one data portion of the data from the remote device.

29. The wireless communication device of claim 28, wherein the transceiver indicates that the transfer of the at least one data portion of the data is incomplete and receives a rescheduling request from the remote device in response to indicating that the transfer is incomplete.

30. The wireless communication device of claim 28, wherein the transceiver indicates that the transfer of the at least one data portion of the data is complete and receives a new request for another data portion of the data from the remote device in response to indicating that the transfer is complete.

31. The wireless communication device of claim 28, wherein the transceiver receives a time period for completion associated with the unicast.

32. The wireless communication device of claim 28, further comprising a scheduling circuit configured to determine whether the time period for completion expired before the transfer was completed.
